(19) United States
(12) Patent Application Publication
(10) Pub. No.: US 2013/0257620 A1
(43) Pub. Date: Oct. 3, 2013

(54) DEVICE AND METHOD FOR DETECTING DRIVER'S ATTENTION THROUGH INTERACTIVE VOICE QUESTIONING

(71) Applicants: Chia-Chun TSOU, New Taipei City (TW); Chih-Heng FANG, New Taipei City (TW); Po-Tsung LIN, New Taipei City (TW)

(72) Inventors: Chia-Chun TSOU, New Taipei City (TW); Chih-Heng FANG, New Taipei City (TW); Po-Tsung LIN, New Taipei City (TW)

(73) Assignee: UTECHZONE CO., LTD., New Taipei City (TW)

(21) Appl. No.: 13/435,714

(22) Filed: Mar. 30, 2012

(51) Int. Cl. G08B 23/00; G06K 9/00

(52) U.S. Cl. 340/573.1; 382/103

(57) ABSTRACT

The present invention provides a device and a method for detecting a driver's attention through interactive voice questioning, which are used to monitor a head action of the driver to determine an attention level of the driver, and mainly operate in a process of asking a question by the device, answering the question by the driver, and making a determination by the device. The device includes an image acquiring unit configured to acquire an image of the driver, a processing unit configured to perform image digital processing on the image, a voice questioning unit configured to give a voice questioning instruction, and a safety determining unit configured to make a value comparison and a determination according to a feature of the image. An alert message will be given to warn the driver if the image fails to comply with requirements of the voice questioning instruction.

### BACKGROUND OF THE INVENTION

1. Technical Field

The present invention relates to a detecting device and a method thereof, and more particularly, to a device and a method for detecting a driver's attention through interactive voice questioning.

2. Description of Related Art

Safety of driving on roads has gradually received great concerns in recent years. Traffic accidents due to inaccurate operations of drivers take place frequently. This is mainly attributed to fatigue of the drivers who lack sleep, a long time of driving at one time without adequate rest, driving under the influence of alcohol and so on. Particularly, traffic accidents often take place due to the drivers' poor mental conditions such as distraction and absence of mind In order to solve such problems, a number of technical solutions have been proposed. For example, China Patent Application No. 200910310326.3 entitled “Driving monitoring device and method” has provided a solution in which a driver's eye regions and hands holding the steering wheel are detected through image capturing so that whether the driver's hands are put on proper regions of the steering wheel or whether the driver's eyes are open or closed due to fatigue can be determined.

U.S. Pat. No. 8,045,766 entitled “Device, program, and method for determining sleepiness” has provided another solution in which facial images of a driver are captured and mental conditions of the driver are determined through calculations in accordance with a specific algorithm. If it is determined that the driver is in poor mental conditions, a gas device and a safety belt vibrating device will be initiated to waken the driver or even a brake controller is used to give an alert.

The aforesaid technical solutions of detecting driving conditions to give an alert for prevention of traffic accidents can all operate reasonably to deliver an effect to some extent. However, neither of them can detect an attention level and mental conditions of the driver quickly and accurately.

### SUMMARY OF THE INVENTION

In view of this, the present invention provides a device and a method for detecting a driver's attention through interactive voice questioning, which operate in a process of asking a question by the device, answering the question by the driver, and making a determination by the device. The device gives a voice prompt; and after hearing the voice prompt, the driver must make a corresponding eye action such as blinking and turning of eyes, a corresponding head action such as nodding and shaking of the head, or a corresponding mouth action such as opening and closing of the mouth. Under normal conditions, of course the driver can make an accurate action so that mental conditions and an attention level of the driver can be determined. As compared to the prior art, the device and the method for detecting a driver's attention through interactive voice questioning according to the present invention can operate simply and be implemented quickly and effectively.

The device for detecting a driver's attention through interactive voice questioning provided by the present invention mainly comprises an image acquiring unit, a voice questioning unit, and a safety determining unit. The image acquiring unit is configured to acquire an image of the driver. The voice questioning unit is configured to give a voice prompt regularly or randomly. The safety determining unit is configured to detect a variation of the image of the driver so as to determine whether the variation complies with requirements of the voice questioning instruction. If the driver fails to make an accurate action corresponding to the voice prompt, then an alert message may be selectively given by a sound making unit to waken and warn the driver.

The present invention further provides a method for detecting a driver's attention through interactive voice questioning, which comprises the following steps of: firstly, giving a voice questioning instruction; then, acquiring an image of the driver; detecting a variation of the image so as to determine whether the variation complies with requirements of the voice questioning instruction; and giving an alert message to waken the driver if the variation of the image of the driver fails to comply with the requirements of the voice questioning instruction.

The detailed features and advantages of the present invention will be described in detail with reference to the preferred embodiment so as to enable persons skilled in the art to gain insight into the technical disclosure of the present invention, implement the present invention accordingly, and readily understand the objectives and advantages of the present invention by perusal of the contents disclosed in the specification, the claims, and the accompanying drawings.

### BRIEF DESCRIPTION OF THE SEVERAL VIEWS OF THE DRAWINGS

FIG. 1 is a schematic view illustrating an architecture of a device of one embodiment of the present invention;

FIG. 2 is a schematic flowchart diagram of a method of one embodiment of the present invention;

FIG. 3A is a continued schematic flowchart diagram of the method of the embodiment of the present invention;

FIG. 3B is another continued schematic flowchart diagram of the method of the embodiment of the present invention;

FIG. 4 is a schematic view illustrating how the device of one embodiment of the present invention is assembled in an application;

FIG. 5 is a schematic view illustrating image acquiring operations of one embodiment of the present invention;

FIG. 6 is a schematic view illustrating operations of a driver according to one embodiment of the present invention; and

FIG. 7 is another schematic view illustrating operations of the driver according to one embodiment of the present invention.

### DETAILED DESCRIPTION OF THE EMBODIMENTS OF THE INVENTION

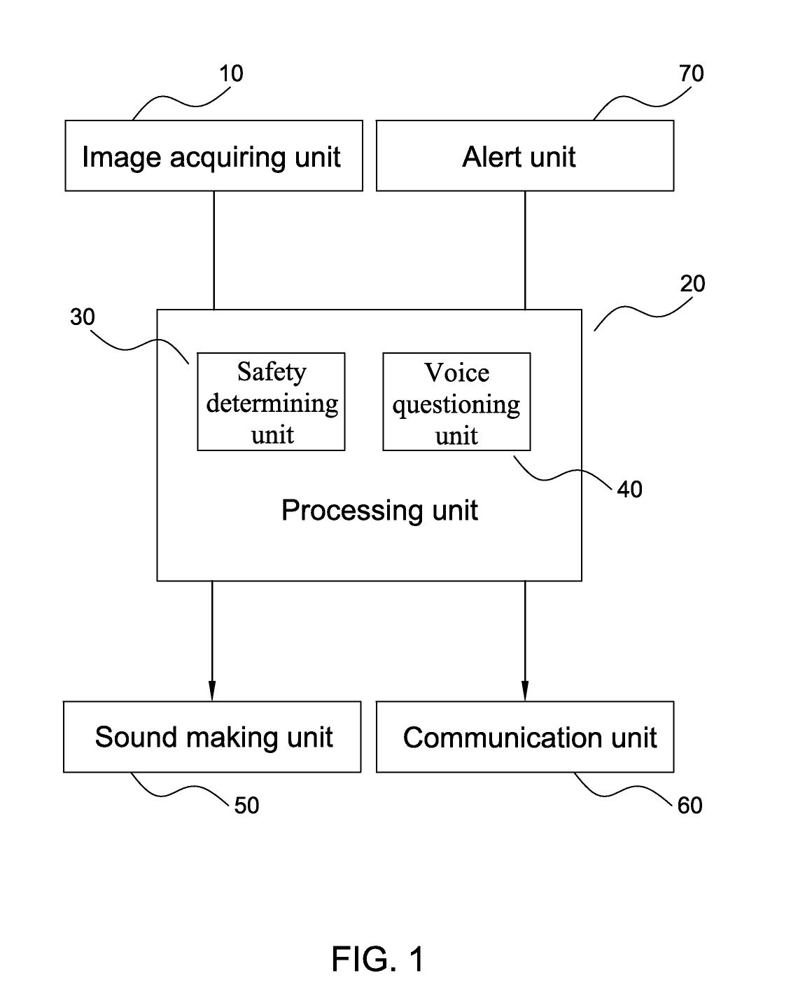

Referring to FIG. 1, there is shown a schematic view illustrating an architecture of a device of one embodiment of the present invention. The device for detecting a driver's attention through interactive voice questioning provided by the embodiment of the present invention mainly comprises an image acquiring unit 10, a processing unit 20, a sound making unit 50, a communication unit 60, and an alert unit 70. The image acquiring unit 10 is connected with the processing unit 20 to acquire a head image of the driver. The processing unit 20 at least comprises a voice questioning unit 40 and a safety determining unit 30. The voice questioning unit 40 gives a voice questioning instruction. The safety determining unit 30 carries out operations on the head image so as to determine a variation of images of the driver's head, face and even eyes and, thereby, detect actions of the driver's head, face and eye.

The voice questioning instruction given by the voice questioning unit 40 may be a voice prompt that can be heard by the driver, and the sound corresponding to the voice questioning instruction is made by the sound making unit 50. The voice prompt has many forms, such as a “firstly look to the left and then look to the right” command, a “firstly look upward and then look downward” command, a “firstly look downward and then look upward” command, a “turn around” command or a “blink” command. After hearing the voice questioning instruction or the voice prompt provided by the voice questioning unit 40, the driver must make a corresponding action, for example, blink for a particular number of times, look to the left and look to the right, or turn the entire head to the left or to the right, nod or shake the head, smile, or open and close the mouth according to the voice questioning instruction. There are many variants of the voice prompt, and what described above are only examples but are not intended to limit the scope of the present invention. Then, the safety determining unit 30 detects variations of continuous images of the driver so as to determine whether the variations comply with requirements of the voice questioning instruction. If the variations of the images of the driver fail to comply with the requirements of the voice questioning instruction, then an alert message will be given; e.g., a sound is made by also the sound making unit 50, a flare light is emitted by the alert unit 70 (e.g., an LED lamp), or the alert message may be selectively transmitted back to the traffic control center through the communication unit 60 so as to indicate the driver's attention status. For the public transportation industry, this design is a particularly effective mechanism for feeding back a driver's status so as to ensure the security of passengers and goods.

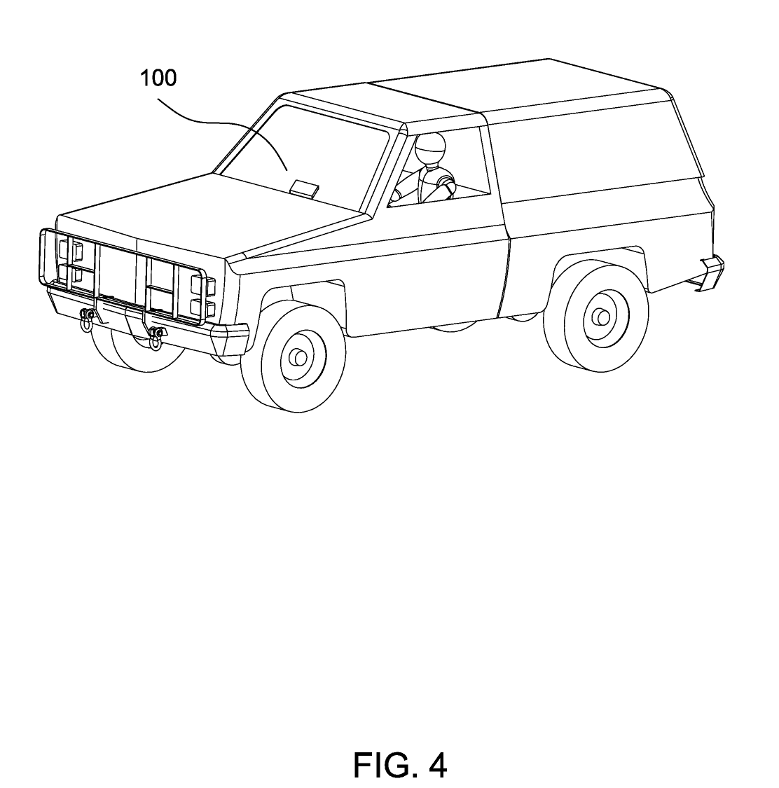

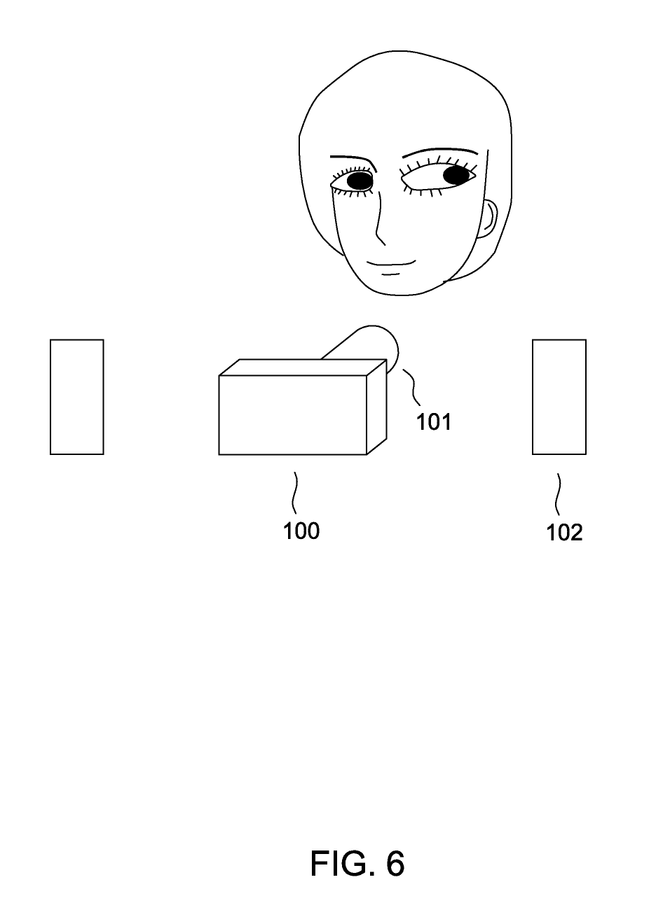

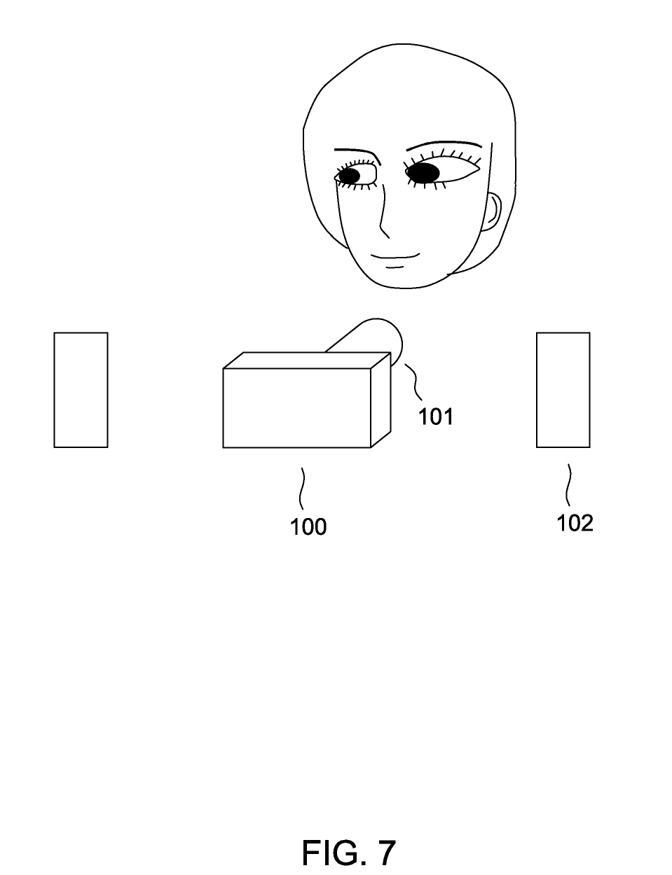

Actual operations of the device for detecting a driver's attention through interactive voice questioning according to the embodiment of the present invention will be described with reference to FIG. 4, FIG. 6 and FIG. 7. The device body 100 of the embodiment of the present invention may be selectively installed in front of the driver's seat, and is preferably installed above the instrument board as shown in FIG. 4. In the device body 100 are disposed the aforesaid processing unit 20 and other electronic components necessary for operations. A video camera 101 is configured to capture an image of the driver, and a sound making unit 102 is configured to give a voice questioning instruction (i.e., a voice prompt). After hearing the voice prompt given by the sound making unit 102, the driver shall make a corresponding action. For example, if the voice prompt is a “firstly look to the left and then look to the right” command, then the driver shall firstly look to the left and then look to the right, as shown in FIG. 6 and FIG. 7. If the driver makes an accurate action, then it represents that the driver is in a clear-headed status and has a certain attention level. Otherwise, if the driver fails to make an accurate action, then an alert message will be given (e.g., an alert sound is made by the sound making unit 102 to waken the driver).

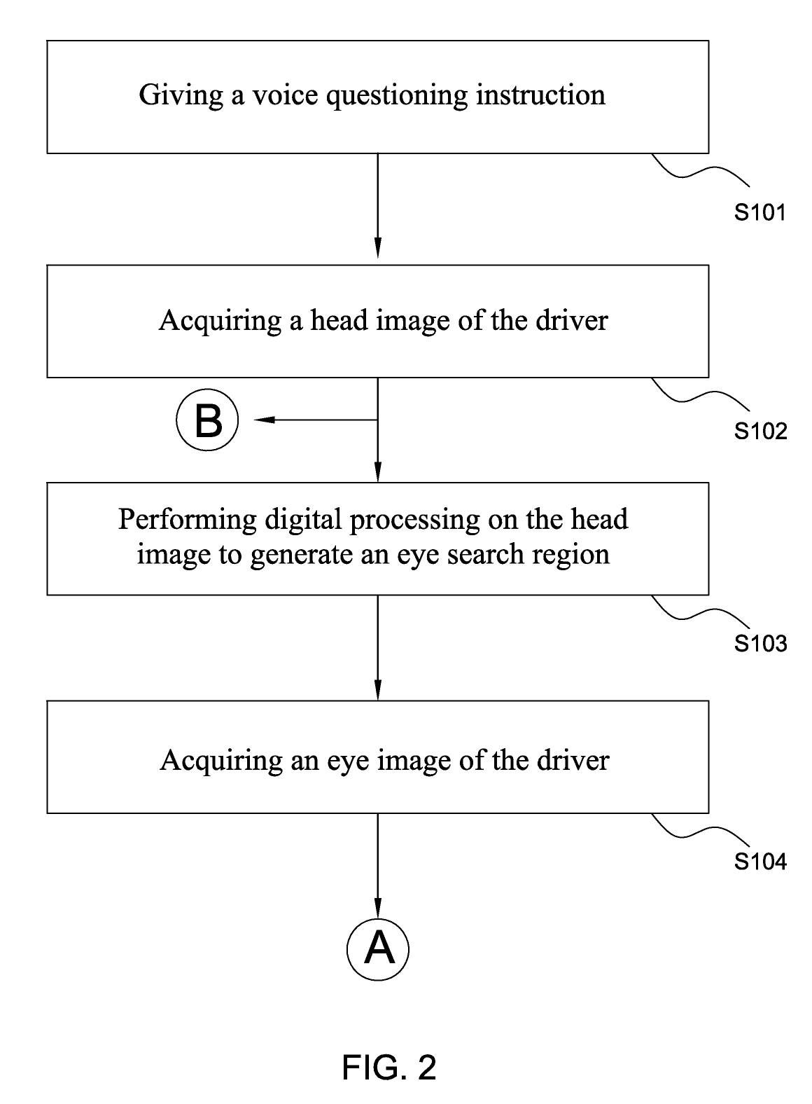

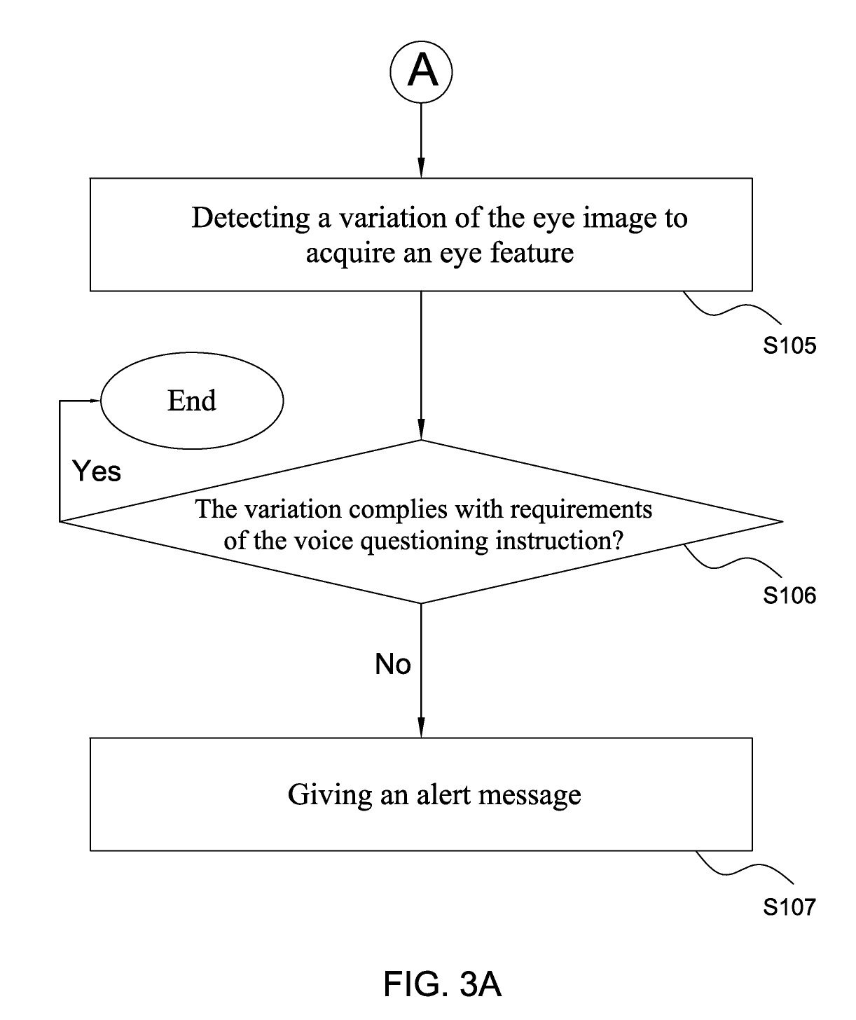

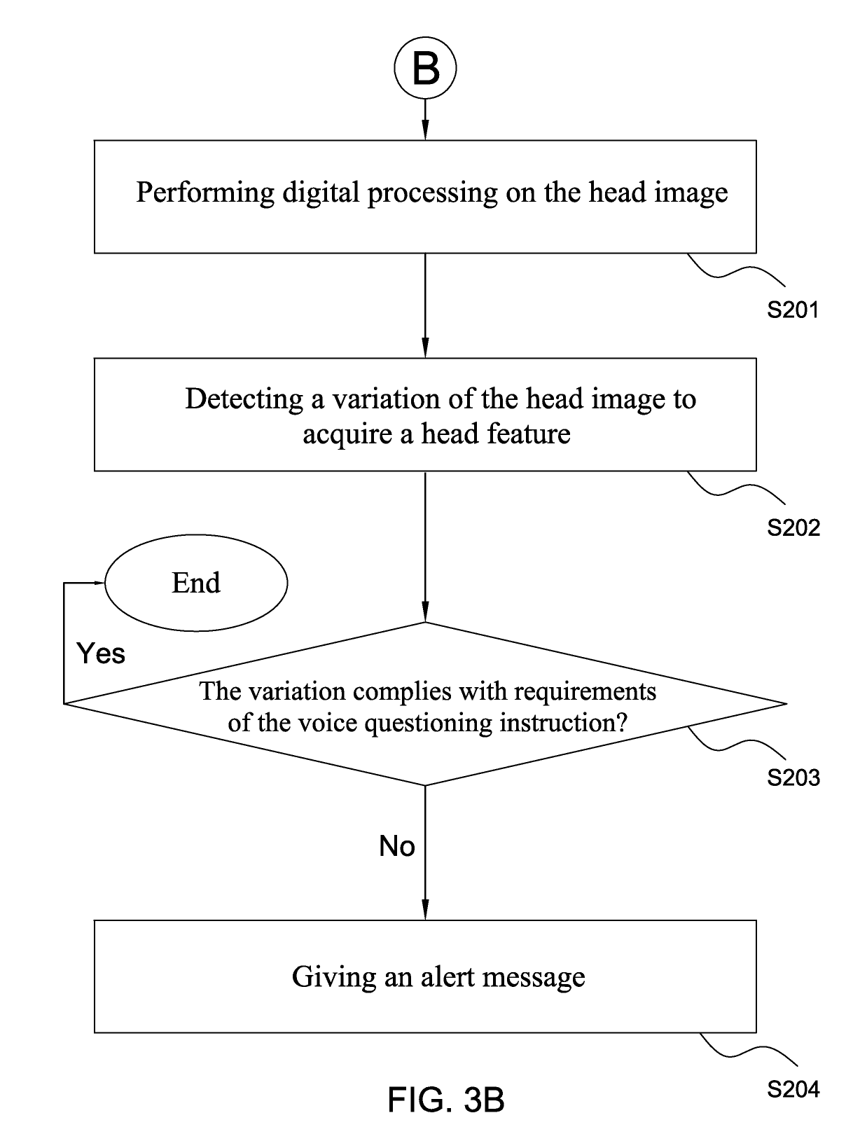

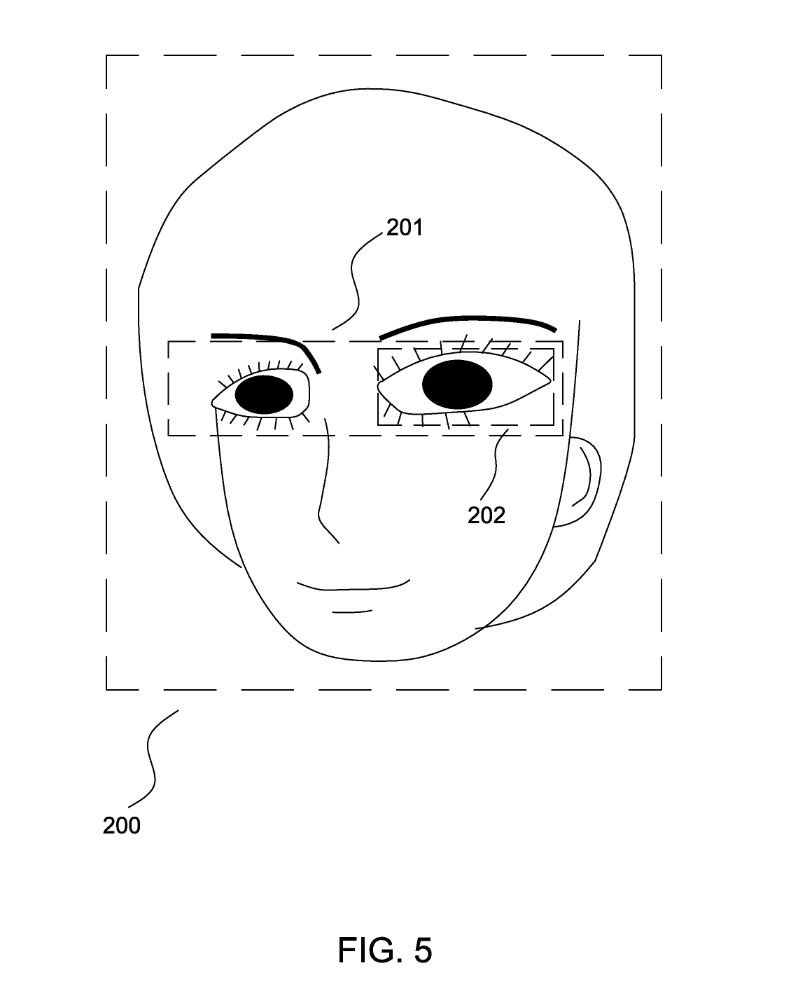

The method for detecting a driver's attention through interactive voice questioning according to one embodiment of the present invention will be described in detail with reference to FIG. 2, FIG. 3A, and FIG. 3B. Firstly, the device gives a voice questioning instruction (S101). The voice questioning instruction may be a voice prompt given by a sound making unit. The voice prompt has many forms such as a “firstly look to the left and then look to the right” command, a “firstly look upward and then look downward” command, a “firstly look downward and then look upward” command, a “turn around” command, or the like. Then, a head image of the driver is acquired (S102). Digital processing is performed on the head image to generate an eye search region (S103) and acquire an eye image of the driver (S104). Referring to FIG. 5 for the step S103 and the step S104, after the head image 200 of the driver is acquired, digital processing is performed within the range of the head image 200 to define an eye search region 201 and find an eye image 202 within the eye search region 201. Furthermore, the steps S102 to S104 are optional, and the eye image may be acquired directly through use of related technologies without the need of firstly acquiring the head image and then acquiring the eye image through analysis.

Subsequent to the step S104, as shown in FIG. 3A, a variation of the eye image is detected to acquire an eye feature (S105) and determine whether the variation of the eye image complies with requirements of the voice questioning instruction (S106). In case the driver makes an accurate action corresponding to the voice questioning instruction (e.g., in response to a voice questioning instruction (i.e., the voice prompt) that asks the driver to firstly look to the left and then look to the right, the driver makes an eye turning action of firstly looking to the left and then looking to the right), then the detecting and determining process can be ended. Otherwise, if the driver fails to make an accurate action according to the voice questioning instruction, then the device will give an alert message (S107) to waken and warn the driver.

Apart from detecting turning of the driver's eyes, the device can also detect a shaking action of the driver's head for determination. Referring to FIG. 2 and FIG. 3B, subsequent to the step S102, step S201 may also be optionally executed to perform digital processing on the head image (S201). The digital processing here can further enhance the image (e.g., enhance the contrast value, the brightness or the like of the image), which helps finding an edge of a feature in the image. Then, a variation of the head image is detected to acquire a head feature (S202) and determine whether the variation complies with requirements of the voice questioning instruction (S203). As in the aforesaid process of the method, if the driver makes an accurate action according to the contents of the voice questioning instruction (i.e., the voice prompt), then the detecting and determining process is ended. Otherwise, an alert message will be given (S204) to waken the driver.

The features of the present invention are disclosed above by the preferred embodiment to allow persons skilled in the art to gain insight into the contents of the present invention and implement the present invention accordingly. The preferred embodiment of the present invention should not be interpreted as restrictive of the scope of the present invention. Hence, all equivalent modifications or amendments made to the aforesaid embodiment should fall within the scope of the appended claims.

What is claimed is:

1. A device for detecting a driver's attention through interactive voice questioning, comprising:
an image acquiring unit, being configured to acquire an image of the driver;
a voice questioning unit, being configured to give a voice questioning instruction; and
a safety determining unit connected with the image acquiring unit and the voice questioning unit, being configured to detect a variation of the image so as to determine whether the variation complies with requirements of the voice questioning instruction.

2. The device for detecting a driver's attention through interactive voice questioning of claim 1, further comprising a sound making unit which is configured to give an alert message if the variation of the image fails to comply with the requirements of the voice questioning instruction.

3. The device for detecting a driver's attention through interactive voice questioning of claim 1, wherein the voice questioning instruction is a voice prompt given by a sound making unit.

4. The device for detecting a driver's attention through interactive voice questioning of claim 3, wherein detecting the variation of the image so as to determine whether the variation complies with requirements of the voice questioning instruction is to detect whether the driver makes a corresponding action according to the voice prompt.

5. The device for detecting a driver's attention through interactive voice questioning of claim 3, wherein the voice prompt is selected from a group consisting of a “firstly look to the left and then look to the right” command, a “firstly look upward and then look downward” command, a “firstly look downward and then look upward” command, a “turn around” command, a “blink” command, a “shake the head” command, a “nod the head” command, a “smile” command, and an “open and close the mouth” command.

6. A method for detecting a driver's attention through interactive voice questioning, comprising the following steps of:
giving a voice questioning instruction;
acquiring an image of the driver;
detecting a variation of the image so as to determine whether the variation complies with requirements of the voice questioning instruction; and
giving an alert message if the variation of the image fails to comply with the requirements of the voice questioning instruction.

7. The method for detecting a driver's attention through interactive voice questioning of claim 6, wherein the voice questioning instruction is given periodically or randomly.

8. The method for detecting a driver's attention through interactive voice questioning of claim 6, wherein the voice questioning instruction is a voice prompt given by a sound making unit.

9. The method for detecting a driver's attention through interactive voice questioning of claim 8, wherein detecting the variation of the image so as to determine whether the variation complies with requirements of the voice questioning instruction is to detect whether the driver makes a corresponding action according to the voice prompt.

10. The method for detecting a driver's attention through interactive voice questioning of claim 8, wherein the voice prompt is selected from a group consisting of a “firstly look to the left and then look to the right” command, a “firstly look upward and then look downward” command, a “firstly look downward and then look upward” command, a “turn around” command, a “blink” command, a “shake the head” command, a “nod the head” command, a “smile” command, and an “open and close the mouth” command.
